(19) United States
(12) Patent Application Publication
(10) Pub. No.: US 2007/0156523 A1
(43) Pub. Date: Jul. 5, 2007

(54) Method and system to process an incentive

(76) Inventors: Deborah Yee-Ky Liu, Santa Clara, CA (US); Charles Eugene Cook, San Jose, CA (US); Michael R. Gainer, Milpitas, CA (US); David Raccah, San Jose, CA (US); Dean Yi-Wai Quan, Burlingame, CA (US); Jennifer Marie Faenza, San Francisco, CA (US); Mary Ku, San Jose, CA (US); Srinivasan Raman, Cupertino, CA (US); Neelika Chakrabarti Choudhury, Cupertino, CA (US); Joseph Edward Black, San Francisco, CA (US)

Correspondence Address: SCHWEGMAN, LUNDBERG, WOESSNER & KLUTH/EBAY, P.O. BOX 2938, MINNEAPOLIS, MN, 55402, US

(21) Appl. No.: 11/323,786

(22) Filed: Dec. 30, 2005

(51) Int. Cl. G06Q 30/00

(52) U.S. Cl. 705/14

(57) ABSTRACT

A method to process an incentive includes, at a commerce server, receiving an incentive identification code that identifies an incentive amount to be used for at least a partial payment of a transaction. A determination is made at the commerce server whether the incentive is valid. If the incentive is determined to the valid, incentive information is communicated to a payment processor server from the commerce server, the incentive information including an authorization that authorizes the payment processor server to transfer the amount as the partial payment for the transaction.

### FIELD

The present application relates generally to the technical field of electronic processing and, in one specific example, to a method and system to process an incentive.

### BACKGROUND

Incentive programs are popular with users that trade electronically. Indeed, operators of commerce servers are continually providing incentive promotion programs to stimulate trade. One of the technical challenges encountered by such operators is the challenge to provide a complete accounting of the use of incentives (e.g., coupons, gift certificates, points, etc.) to buyers. For example, many operators issue and redeem incentives and exclude the incentives from payment processing which is typically performed by a different network entity (e.g., payment processor). Thus, a statement or report issued by the payment processor may show that a buyer paid a reduced price but may fail to show that the buyer redeemed incentives to achieve the reduced price. Other operators may rely on payment processing entity to issue and redeem the incentives. This approach also has disadvantages because the payment processor may not be motivated to issue incentives that are specifically targeted to the users of the commerce server.

### SUMMARY

According to one embodiment, there is provided a method and a system. The method comprises receiving an incentive identification code that identifies an incentive amount to be used for at least a partial payment for a transaction; determining whether the incentive is valid; and if the incentive is valid, communicating incentive information to a payment processor server, the incentive information including an authorization that authorizes the payment processor server to transfer the incentive amount as the at least partial payment for the transaction.

### BRIEF DESCRIPTION OF THE DRAWINGS

The present disclosure is illustrated by way of example and not limitation in the figures of the accompanying drawings, in which like references indicate similar elements and in which:

FIGS. 1A and 1B are network diagrams depicting a system to validate an incentive and process payment for an incentive;

FIGS. 2A and 2B are network diagrams depicting a further system to validate an incentive and process payment for an incentive;

FIGS. 3A and 3B are network diagrams depicting a system, according to one example embodiment of the present disclosure, to issue an incentive, validate an incentive and process payment for an incentive;

FIG. 4 is a network diagram depicting systems, according to one example embodiment of the present disclosure, that issue incentives, validate incentives and process payments for incentives;

FIG. 5 is a block diagram illustrating an incentive validation system, according to an example embodiment of the present disclosure;

FIG. 6 is a block diagram illustrating marketplace applications, according to an example embodiment of the present disclosure;

FIG. 7 is a block diagram illustrating database tables, according to one embodiment;

FIG. 8 is a block diagram illustrating an incentives table, according to one embodiment;

FIG. 9 is a block diagram illustrating a user table, according to one embodiment;

FIG. 10 is a block diagram illustrating an incentive engine, according to one embodiment;

FIG. 11 is a block diagram illustrating a payment applications, according to one embodiment;

FIG. 12 is a flowchart illustrating a method to issue an incentive, according to one embodiment;

FIG. 12 is a flowchart illustrating a method to process an incentive, according to one embodiment;

FIGS. 14-20 are representations of user interfaces, according to one embodiment; and

FIG. 21 is a block diagram of a machine, according to one embodiment.

### DETAILED DESCRIPTION

A method and system to process an incentive are described. In the following description, for purposes of explanation, numerous specific details are set forth in order to provide a thorough understanding of the present disclosure. It will be evident, however, to one skilled in the art that the present disclosure may be practiced without these specific details.

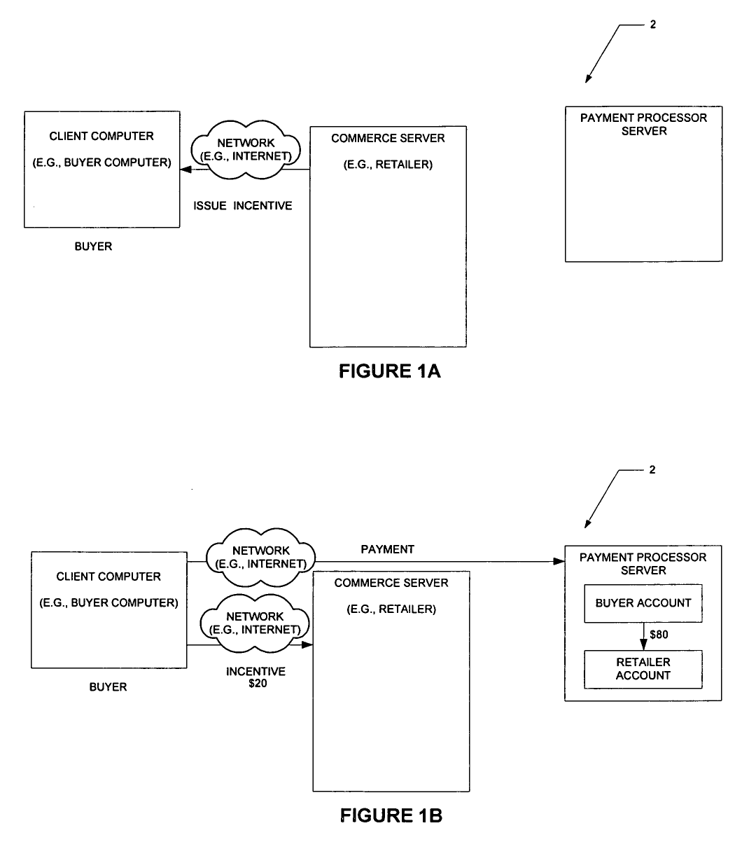

FIGS. 1A and 1B are network diagrams depicting a system 2 to process incentives. In the present example, the commerce server is operated by a retailer that facilitates the transaction of items between buyers and a retailer. The commerce server may further issue incentives to promote the transaction of items.

FIG. 1A illustrates a commerce server, a client computer operated by a buyer (e.g., buyer computer), and a payment processor server. The commerce server is shown to issue an incentive over a network to a buyer computer. For example, the commerce server may email the incentive to the buyer computer. The incentive may be a coupon, a gift certificate, or points that may be redeemed by the buyer from the commerce server according to the requirements of the incentive.

FIG. 1B is a network diagram depicting the buyer computer, as operated by a buyer, redeeming the incentive from the commerce server. The buyer computer communicates the incentive to the commerce server and further authorizes payment to a payment processor server. For example, the buyer may want to purchase a book valued at $100 and further redeem a coupon towards the purchase of the book, the coupon valued at $20. To this end, the buyer, via the buyer computer, communicates an authorization to the payment processor server to transfer a payment of $80 from an account of the buyer to an account of the retailer. Further, the buyer computer may communicate an incentive identification code to the commerce server that identifies the incentive. Responsive to receipt of the incentive identification code, the commerce server validates the incentive by ensuring that the requirements of the incentive are satisfied. For example, the incentive may require that the buyer be a first time buyer on the commerce server before redeeming the incentive. The payment processor server does not process the incentive; rather, the commerce server validates and processes the incentive. A disadvantage of this approach is that the incentive is not visible at the payment processor server. For examples, records and statements would not show the incentive as part of the transaction. Another disadvantage of this approach is that the commerce server is required to perform payment processing functions with respect to the value of the coupon.

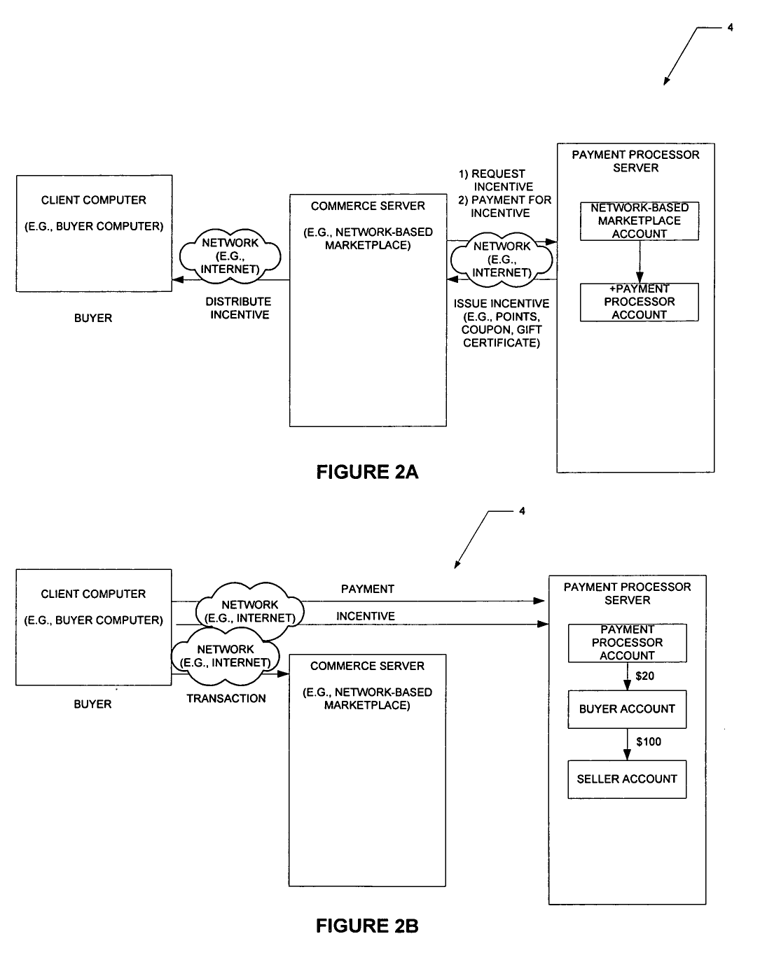

FIGS. 2A and 2B are network diagrams depicting a further system 4 to process incentives. In the present example, the commerce server is operated by a network-based marketplace that facilitates the transaction of items between buyers and sellers and further may distribute incentives to promote the transaction of items between the buyers and sellers.

FIG. 2A illustrates a client computer (e.g., buyer computer), a commerce server, and a payment processor server. The network-based marketplace is shown to communicate a request for an incentive to the payment processor server and authorization of payment for the incentive to the payment processor server. Responsive to receipt of the request and the authorization, the payment processor server issues one or more incentives to the network-based marketplace and transfers an amount corresponding to the value of the coupons from an account of the network-based marketplace to an account of the payment processor. Finally, the commerce server is shown to distribute the incentive to the buyer. For example, the incentive may be a coupon.

FIG. 2B illustrates redemption of the previously issued coupon. In the present example, the network-based marketplace records a transfer of merchandise from a seller to a buyer responsive to receipt of payment and an incentive at the payment processor server. For example, the buyer may receive a book valued at $100 from the seller by authorizing the payment processor server to transfer $100 from the buyers account to the sellers account. Further, the buyer may reduce the net cost to himself by redeeming an incentive valued at $20. The buyer may redeem the coupon by providing an incentive identification code to the payment processor server which, in turn, validates the coupon and transfers $20 from an account of the payment processor server to an account of the buyer. While this approach makes the incentive visible at the payment processor server, it has the disadvantage of requiring the payment processor server to issue and validate the incentive. Issuance at the network-based marketplace enables an administrator of the network-based marketplace to be more cognizant of the types of incentives that may appeal to their users (e.g., buyers and sellers). Further, validation at the network-based marketplace makes network-based marketplace information readily available (e.g., in real-time) and easily accessible. For example, a coupon that requires network-based marketplace information that includes a count of the number of items purchased in a period of time on the network-based marketplace may be easily validated at the network-based marketplace.

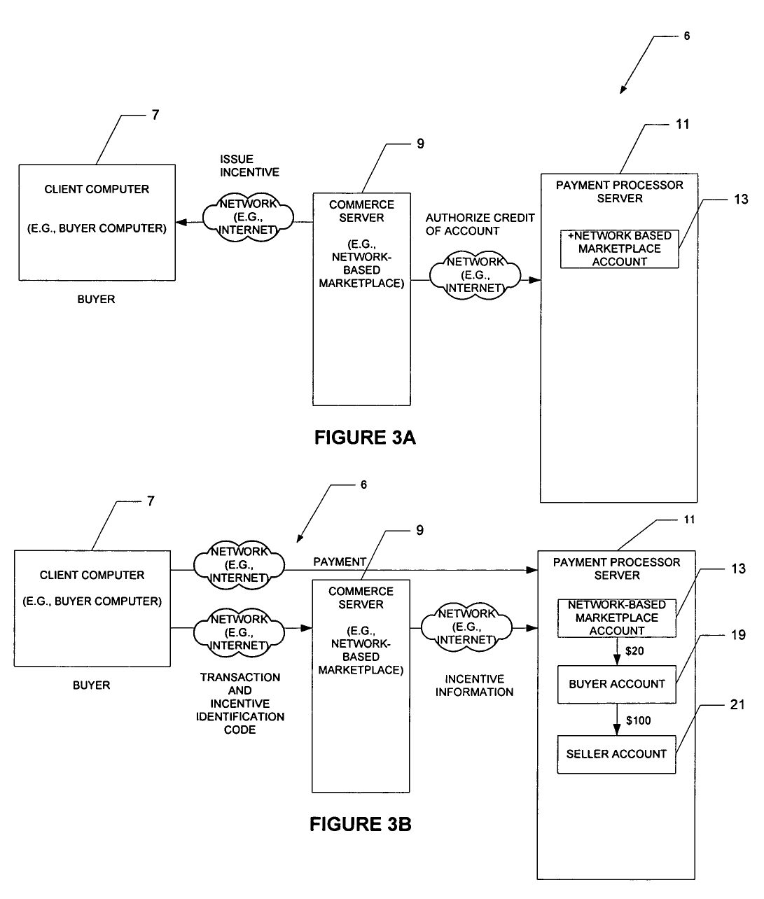

FIGS. 3A and 3B are network diagrams depicting a system 6, according to one embodiment of the present disclosure, to process incentives. The system 6 seeks to address certain of the disadvantages of the previously described systems 2 and 4 by enabling, inter alia, issuance and validation of the incentive at the commerce server, providing visibility of the incentive at the payment processor server, and enabling payment processing functions related to the incentive at the payment processor server.

FIG. 3A illustrates the system 6, according to one embodiment, that includes a client computer (e.g., buyer computer) 7, a commerce server 9 (e.g., network-based marketplace), and payment processor server 11. The network-based marketplace is shown to issue an incentive to the buyer and to authorize the credit of an account 13 of the network-based marketplace on the payment processor server 11. For example, the incentive may be a coupon and the account 13 may be used to redeem the value of the coupon.

FIG. 3B illustrates redemption of the previously issued coupon, according to one embodiment. In the present example, the commerce server 9 (e.g., network-based marketplace) records a transaction of merchandise from a seller to a buyer responsive to receipt of a payment at the payment processor server 11, and validation of the coupon at the commerce server 9. For example, the commerce server 9 may receive an incentive identification code that may be used to identify the coupon. If validation is successful, the commerce server 9 may communicate incentive information to the payment processor server 11 that includes an authorization to transfer an amount (e.g., an coupon amount) from the account 13 of the network-based marketplace to an account 19 of the buyer and to transfer an amount (e.g., transaction amount) to an account 21 of the seller.

The example system 6 may provide a number of advantages over the systems 2, 4. First, the commerce server 9 (e.g., network based marketplace) issues and validates the coupon. Issuance and validation by the commerce server 9 may provide relatively increased flexibility with regard to these functions. Further, the present example illustrates the coupon as visible at the payment processor server 11, thus enabling an accounting of the transaction that includes the redemption of the coupon. Finally, the present example illustrates that the commerce server 9 is relieved of payment processing functions with regard to the coupon. It will be appreciated that other embodiments of the system 6 may include a seller of the network-based marketplace utilizing a service of the network-based marketplace to issue and redeem an incentive with regard to the transaction of items offered for sale or auction by the seller. Further, such an embodiment may include a payment processor server 11 that provides payment functionality for such seller issued incentives.

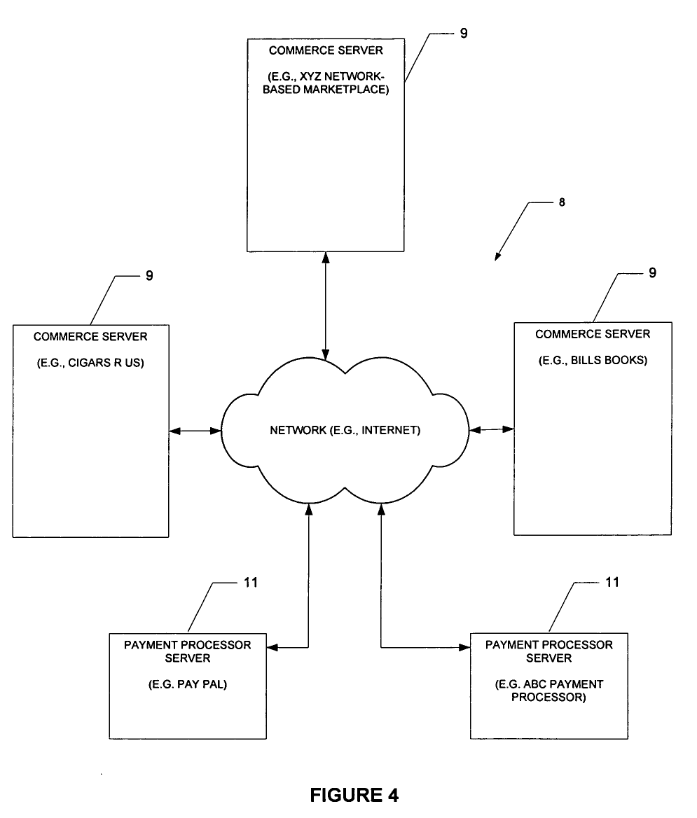

FIG. 4 is a network diagram depicting a system 8, according to one example embodiment. The system 8 illustrates multiple commerce servers 9 that issue and validate incentives and multiple payment processor servers 11 that process payments for the incentives. The system 8 highlights the above described advantages with regard to multiple commerce servers 9 and multiple payment processor servers 11.

### Platform Architecture

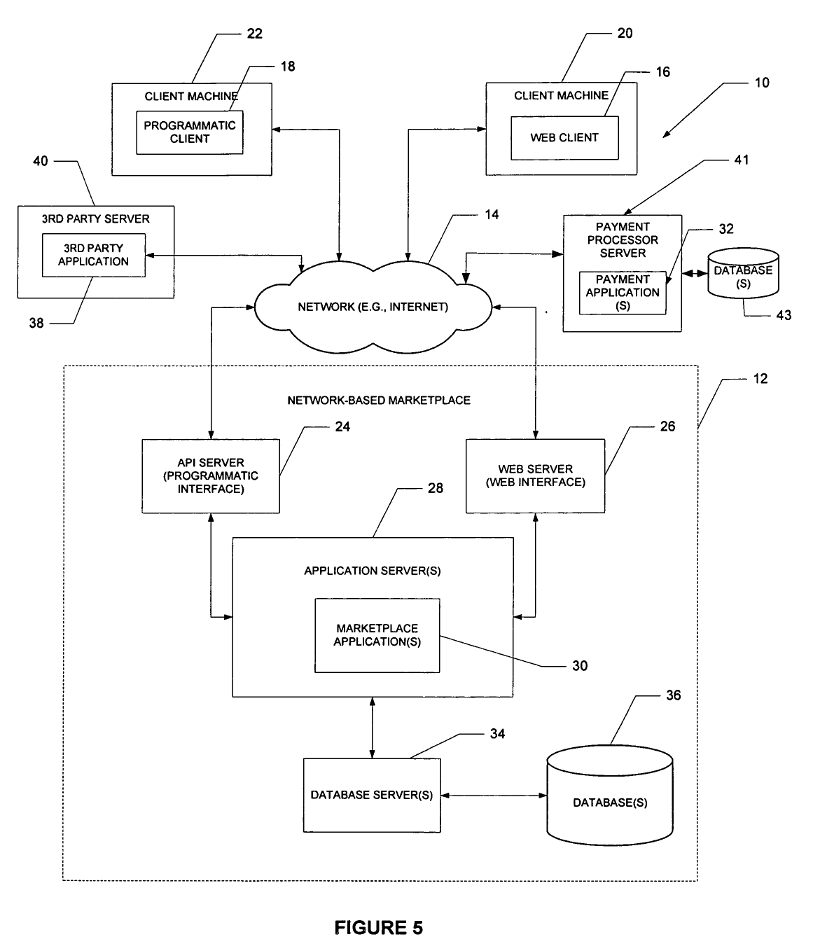

FIG. 5 is a network diagram depicting a system 10, according to one example embodiment, having a client-server architecture. A commerce platform or commerce server, in the example form of a network-based marketplace 12, provides server-side functionality, via a network 14 (e.g., the Internet) to one or more clients. FIG. 1 illustrates, for example, a web client 16 (e.g., a browser, such as the Internet Explorer browser developed by Microsoft Corporation of Redmond, Wash. State), and a programmatic client 18 executing on respective client machines 20 and 22. While the mother example is described in terms of a network-based marketplace 12, it will readily be appreciated that the commerce platform or commerce server may be operated by a retailer (e.g., Amazon.com), and not a marketplace maker or operator (e.g., eBay.com).

Turning specifically to the network-based marketplace 12, an Application Program Interface (API) server 24 and a web server 26 are coupled to, and provide programmatic and web interfaces respectively to, one or more application servers 28. The application servers 28 host one or more marketplace applications 30. The application servers 28 are, in turn, shown to be coupled to one or more database servers 34 that facilitate access to one or more databases 36. The marketplace applications 30 provide a number of marketplace functions and services to users that access the marketplace 12.

While the system 10 shown in FIG. 1 employs a client-server architecture, the present disclosure is of course not limited to such an architecture, and could equally well find application in a distributed, or peer-to-peer, architecture system. The various marketplace applications 30 could also be implemented as standalone software programs, which do not necessarily have networking capabilities.

The web client 16 may access the various marketplace applications 30 via the web interface supported by the web server 26. Similarly, the programmatic client 18 accesses the various services and functions provided by the marketplace applications 30 via the programmatic interface provided by the API server 24. The programmatic client 18 may, for example, be a seller application (e.g., the TurboLister application developed by eBay Inc., of San Jose, Calif.) to enable sellers to author and manage listings on the marketplace 12 in an off-line manner, and to perform batch-mode communications between the programmatic client 18 and the network-based marketplace 12.

FIG. 5 also illustrates a payment processor server 41 hosting payment applications 32 (e.g., applications developed by PayPal, Inc., of San Jose, Calif.). The payment applications 32 provide a number of payment services and functions to users. For example, with regard to incentive programs, the payment applications 32 may allow users on the network-based marketplace 12 and the network-based marketplace 12 to credit value in accounts stored on a database 43. The accounts may be associated with incentives that are issued by the network-based marketplace 12 or by users of the network-based marketplace 12. The accounts may subsequently be debited based on an authorization communicated from the network-based marketplace 12. The various payment applications 32 could also be implemented as standalone software programs, which do not necessarily have networking capabilities.

FIG. 5 also illustrates a third party application 38, executing on a third party server machine 40, as having programmatic access to the network-based marketplace 12 via the programmatic interface provided by the API server 24. For example, the third party application 38 may, utilizing information retrieved from the network-based marketplace 12, support one or more features or functions on a website hosted by the third party. The third party website may, for example, provide one or more promotional, marketplace or payment functions that are supported by the relevant applications of the network-based marketplace 12.

### Marketplace Applications

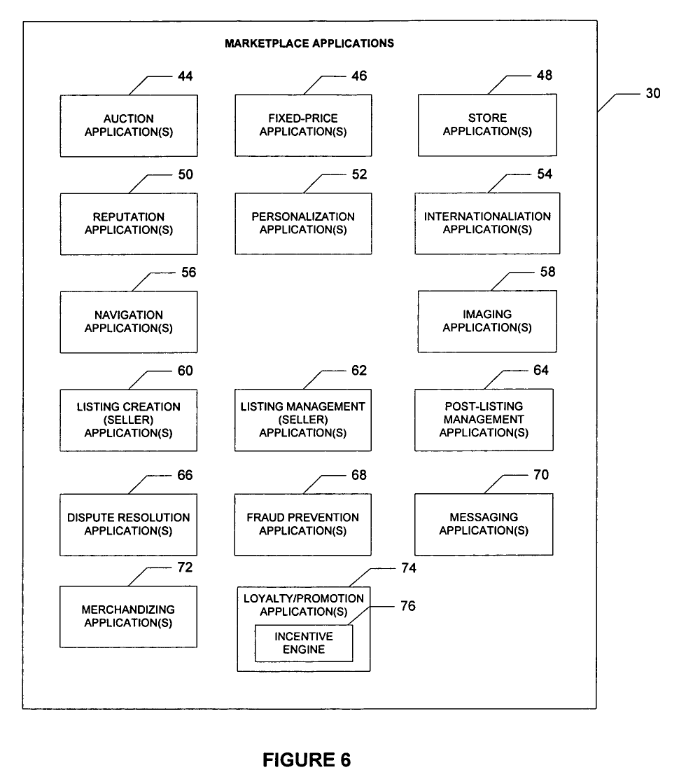

FIG. 6 is a block diagram illustrating multiple marketplace applications 30 that, in one example embodiment, are provided as part of the network-based marketplace 12. The network-based marketplace 12 may provide a number of listing and price-setting mechanisms whereby a seller may list goods or services for sale, a buyer can express interest in or indicate a desire to purchase such goods or services, and a price can be set for a transaction pertaining to the goods or services. To this end, the marketplace applications 30 are shown to include one or more auction applications 44 which support auction-format listing and price setting mechanisms (e.g., English, Dutch, Vickrey, Chinese, Double, Reverse auctions etc.). The various auction applications 44 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 46 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with an auction-format listing, and allow a buyer to purchase goods or services, which are also being offered for sale via an auction, for a fixed-price that is typically higher than the starting price of the auction.

Store applications 48 allow sellers to group their listings within a “virtual” store, which may be branded and otherwise personalized by and for the sellers. Such a virtual store may also offer promotions, incentives and features that are specific and personalized to a relevant seller.

Reputation applications 50 allow parties that transact utilizing the network-based marketplace 12 to establish, build and maintain reputations, which may be made available and published to potential trading partners. Consider that where, for example, the network-based marketplace 12 supports person-to-person trading, users may have no history or other reference information whereby the trustworthiness and credibility of potential trading partners may be assessed. The reputation applications 50 allow a user, for example through feedback provided by other transaction partners, to establish a reputation within the network-based marketplace 12 over time. Other potential trading partners may then reference such a reputation for the purposes of assessing credibility and trustworthiness.

Personalization applications 52 allow users of the marketplace 12 to personalize various aspects of their interactions with the marketplace 12. For example a user may, utilizing an appropriate personalization application 52, create a personalized reference page at which information regarding transactions to which the user is (or has been) a party may be viewed. Further, a personalization application 52 may enable a user to personalize listings and other aspects of their interactions with the marketplace 12 and other parties.

In one embodiment, the network-based marketplace 12 may support a number of marketplaces that are customized, for example, for specific geographic regions. A version of the marketplace 12 may be customized for the United Kingdom, whereas another version of the marketplace 12 may be customized for the United States. Each of these versions may operate as an independent marketplace, or may be customized (or internationalized) presentations of a common underlying marketplace.

Navigation of the network-based marketplace 12 may be facilitated by one or more navigation applications 56. For example, a search application enables key word searches of listings published via the marketplace 12. A browse application allows users to browse various category, catalogue, or inventory data structures according to which listings may be classified within the marketplace 12. Various other navigation applications may be provided to supplement the search and browsing applications.

In order to make listings, available via the network-based marketplace 12, as visually informing and attractive as possible, the marketplace applications 30 may include one or more imaging applications 58 utilizing which users may upload images for inclusion within listings. An imaging application 58 also operates to incorporate images within viewed listings. The imaging applications 58 may also support one or more promotional features, such as image galleries that are presented to potential buyers. For example, sellers may pay an additional fee to have an image included within a gallery of images for promoted items.

Listing creation applications 60 allow sellers conveniently to author listings pertaining to goods or services that they wish to transact via the marketplace 12, and listing management applications 62 allow sellers to manage such listings. Specifically, where a particular seller has authored and/or published a large number of listings, the management of such listings may present a challenge. The listing management applications 62 provide a number of features (e.g., auto-relisting, inventory level monitors, etc.) to assist the seller in managing such listings. One or more post-listing management applications 64 also assist sellers with a number of activities that typically occur post-listing. For example, upon completion of an auction facilitated by one or more auction applications 44, a seller may wish to leave feedback regarding a particular buyer. To this end, a post-listing management application 64 may provide an interface to one or more reputation applications 50, so as to allow the seller conveniently to provide feedback regarding multiple buyers to the reputation applications 50.

Dispute resolution applications 66 provide mechanisms whereby disputes arising between transacting parties may be resolved. For example, the dispute resolution applications 66 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 68 implement various fraud detection and prevention mechanisms to reduce the occurrence of fraud within the marketplace 12.

Messaging applications 70 are responsible for the generation and delivery of messages to users of the network-based marketplace 12, such messages for example advising users regarding the status of listings at the marketplace 12 (e.g., providing “outbid” notices to bidders during an auction process or to provide promotional and merchandising information to users).

Merchandising applications 72 support various merchandising functions that are made available to sellers to enable sellers to increase sales via the marketplace 12. The merchandising applications 80 also operate the various merchandising features that may be invoked by sellers, and may monitor and track the success of merchandising strategies employed by sellers.

The network-based marketplace 12 itself or a user of the network-based marketplace 12 may operate loyalty programs that are supported by one or more loyalty/promotions applications 74. The promotion applications 74 are shown to include an incentive engine 76 that may be utilized to issue incentives (e.g., coupons, points, gift certificates, etc.), validate incentives and communicate incentive information to the payment processor server 41 that includes an authorization to transfer money between accounts in support of redemption of the incentives. In another embodiment, the promotion applications 74 may, for example, enable a buyer to earn loyalty or promotions points for each transaction established and/or concluded with a particular seller, and be offered a reward for which accumulated loyalty points can be redeemed.

### Data Structures

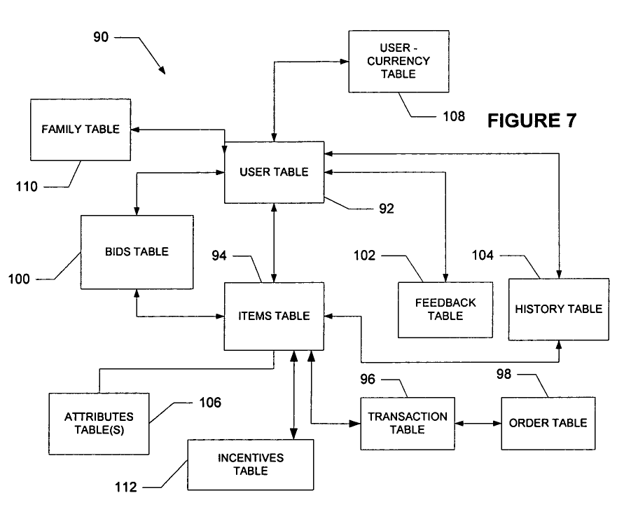

FIG. 7 is a high-level entity-relationship diagram, illustrating various tables 90 that may be maintained within the databases 36, and that are utilized by and support the marketplace applications 30. A user table 92 contains a record for each registered user of the network-based marketplace 12, and may include identifier, address and financial instrument information pertaining to each such registered user. A user may, it will be appreciated, operate as a seller, a buyer, or both, within the network-based marketplace 12. In one example embodiment, a buyer may be a user that has accumulated value (e.g., national currency or incentives including gift certificates, coupons, points, etc.) and is then able to exchange the accumulated value for items that are offered for sale on the network-based marketplace 12. The user table 92 may further be used to maintain coupon generation information, gift certificate generation information, and points generation information that may be used to maintain incentive campaigns started by the user. Indeed the user, acting as a seller, may issue and redeem incentives via the network-based marketplace 12.

The tables 90 also includes an items table 94 in which are maintained item records for goods and services that are available to be, or have been, transacted via the marketplace 12. Each item record within the items table 94 may furthermore be linked to one or more user records within the user table 92, so as to associate a seller and one or more actual or potential buyers with each item record.

A transaction table 96 contains a record for each transaction (e.g., a purchase transaction) pertaining to items for which records exist within the items table 94.

An order table 98 is populated with order records, each order record being associated with an order. Each order, in turn, may be with respect to one or more transactions for which records exist within the transactions table 96.

Bid records within a bids table 100 each relate to a bid received at the network-based marketplace 12 in connection with an auction-format listing supported by an auction application 44. A feedback table 102 is utilized by one or more reputation applications 50, in one example embodiment, to construct and maintain reputation information concerning users. A history table 104 maintains a history of transactions to which a user has been a party. One or more attributes tables 106 record attribute information pertaining to items for which records exist within the items table 94. Considering only a single example of such an attribute, the attributes tables 106 may indicate a currency attribute associated with a particular item, the currency attribute identifying the currency of a price for the relevant item as specified in by a seller.

An incentives table 112 maintains system incentive information. For example, system incentive information may include incentive generation information (e.g., coupon generation information, gift certificate generation information, and points generation information) that may be used to generate and maintain incentive campaigns whereby incentives are issued and redeemed by the network-based marketplace 12.

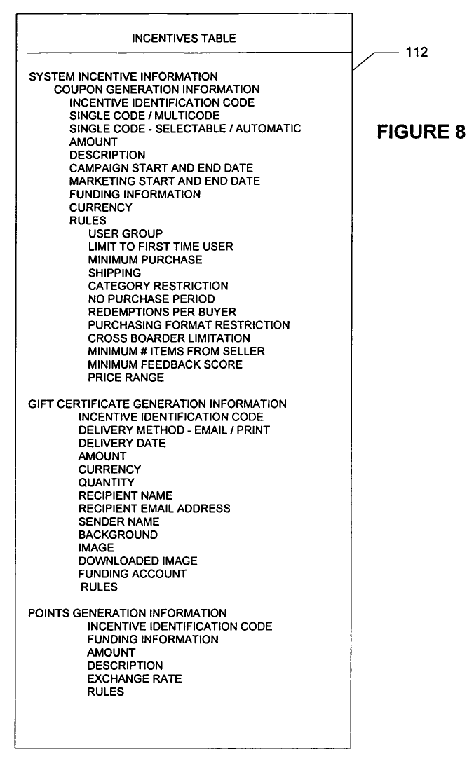

FIG. 8 is a block diagram illustrating an incentives table 112, according to one example embodiment. The incentives table 112 is shown to include system incentive information including coupon generation information, gift certificate generation information and points generation information. The generation information is stored in the incentives table 112 responsive to an administrator of the network-based marketplace 12 designing a promotional campaign via various user interfaces. The generation information may subsequently be utilized by the network-based marketplace 12 to issue or generate incentives that may be communicated to users of the network-based marketplace (e.g., email) or obtained by users from web pages of the network-based marketplace 12. It will be appreciated that multiple campaigns of each of the types of incentives mentioned (e.g., coupons, gift certificates, points) may be designed and stored in the incentives table 112.

The coupon generation information includes an incentive identification code that identifies the coupon. A single code indicates that all coupons for the particular coupon campaign have the same incentive identification code and a multi-code indicates that each of the coupons has unique codes (e.g., incentive identification code entered+system generated number). Site indicates a cluster of application servers 28 from which the incentive may issue. In one embodiment, the sites may roughly correspond to national jurisdictions (e.g., US, Canada, England, France, etc). Further, users of the network-based marketplace 12 may be required to sign-on to the network-based marketplace 12 via a single site.

Single code coupons may be selectable or automatic. Selectable coupons may require a user to enter an incentive identification code to redeem the coupon. Automatic coupons may automatically be applied by the network-based marketplace 12 at checkout time. An “amount” in the example incentives table 112 refers to the incentive amount of the coupon. A “description” is a string that describes the coupon campaign and may appear on various web pages of the network-based marketplace 12 or in communications from the network-based marketplace 12 (e.g., email, web chat, instant messaging, etc.). The “campaign start date is used to schedule the start date for issuing coupons and the “campaign end date” is used to schedule the end date for issuing coupons. The “marketing start date” is used to schedule the start date for promoting the coupon campaign and the “marketing end date” is used to schedule the end date for promoting the coupon campaign. Funding information includes budget information and funding account information. For example, “funding account” information may include an account identifier that identifies an account on the payment processor that may be used to fund redemption of a coupon that was issued by the corresponding campaign. “Currency” identifies the type of national currency of the coupon (e.g. US Dollar, French Francs, etc.). In one embodiment, a coupon may, through the application of a rule, only be redeemed for an item with a matching national currency. Other embodiments may not limit the redemption of a coupon to matching currencies but may automatically perform currency conversions as required.

Rules may be utilized to validate the coupon. For example, one rule may specify that coupons issued from a specific campaign may only be redeemed by users that belong to an identified group (e.g., power sellers, VIP buyers, etc.) on the network-based marketplace 12. Another rule may require that coupons issued from a specific campaign may only be redeemed by a first time user. For example, a user who had recently become a member of the network-based marketplace 12 (e.g., established an account in the last six months) may be deemed a first time user. A minimum purchase price may require merchandise to total a minimum amount of money at checkout time before the coupon is redeemed. Shipping may identify a coupon that is exclusively applied to shipping charges. Category restriction may require a transacted item to be categorized in the identified categories before the coupon may be redeemed. For example, a campaign that identifies a “toys” category of item on the network-based marketplace 12 may be used issue a coupon that may only be redeemed for a transacted item classified in the “toys” category. “No purchase period” information identifies a period of time in which no purchases may have occurred by the holder of the coupon prior to redemption of the coupon. “Redemptions per buyer” may indicate the number of times that a particular coupon can be reused by a buyer. For example, a single coupon for $2.00 off the purchase of a “Darth Vader light Saber” may indicate that it may be used for the purchase of three Darth Vader Light Sabers. “Purchasing format restriction” information may indicate a type of purchasing format that is required to redeem the coupon. For example, purchasing format may require that the coupon be redeemed in conjunction with an item that was won in an auction or that the coupon may be redeemed in conjunction with an item that was bought for a fixed price (e.g., Buy it Now). “Cross border limitation” information identifies whether coupons that issue from a specific campaign may be redeemed from a site that is different from the site corresponding to the specific campaign (e.g., see “site” above). “Minimum feedback score” information may be used to create a campaign that issues coupons that may be redeemed by a user that has a feedback score that transgresses a specified feedback threshold (e.g., exceeds a specified minimum feedback score). “Price range” may be used to create a campaign that issues coupons that may be redeemed by a user that proceeds to checkout with items with prices that total to a sum that is contained by the price range.

The gift certificate generation information includes an incentive identification code, an amount, a currency, funding information, and rules as previously described. In addition, the gift certificate generation information specifies a delivery method that may be used to specify whether the campaign issues the gift certificate via email or print (e.g., posting on a web page that may be printed by a user). “Delivery date” may be used to schedule the date of email delivery. “Quantity” specifies the number of gift certificates that may generated for a specific campaign. Recipient name, recipient email address, and sender name are self descriptive. “Background” may be utilized by the network-based marketplace 12 to identify a background for the gift certificate (e.g., patterns, colors, designs, etc.). “Downloaded image” enables the administrator to identify a network location of an image (e.g., URL, file location, etc.).

The points generation information includes information that may be utilized by the network-based marketplace 12 to create a campaign that issues and redeems points. Points may be redeemed by users for monetary value, which may in turn be utilized as payment for an item. For example, points may be redeemable for a particular type of currency (e.g., US dollars) at a particular exchange rate (e.g., 1 point=1 cent). The points generation information includes an incentive identification code, an amount, funding information, and rules as previously described.

While certain types of incentive information are described exclusively in association with coupon generation information, gift certificate generation information, or points generation information, it will be appreciated by one skilled in the art that such incentive information may be utilized in with regard to other incentive types.

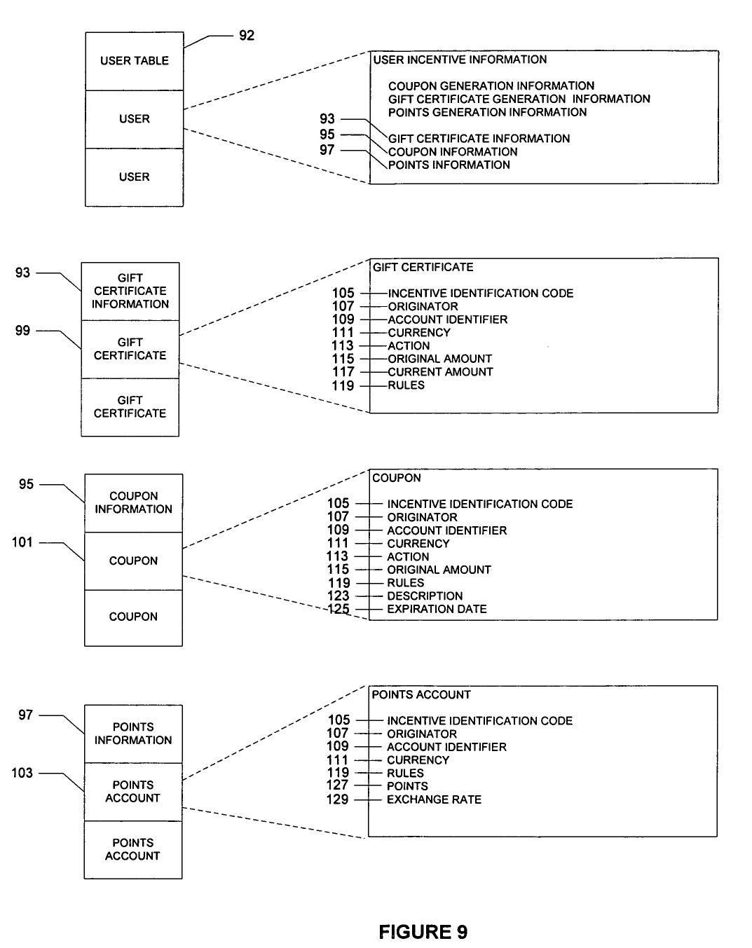

FIG. 9 is a block diagram illustrating a user table 92 according to one embodiment. The user table 92 includes an entry for each user that may be registered to trade on the network-based marketplace 12. Each entry may include user information that includes coupon generation information, gift certificate generation information, points generation information, as previously described with regard to system incentive generation. Each entry further includes gift certificate information 93, coupon information 95 and points information 97.

The coupon, gift certificate, and points generation information is stored in the corresponding entry of the users table 92 responsive to a user (e.g., seller) of the network-based marketplace 12 designing a promotional campaign. The generation information may subsequently be utilized by the respective user to issue or generate incentives that may be communicated to users of the network-based marketplace 12 or obtained by users of the network-based marketplace 12 from web pages of the network-based marketplace 12. It will be appreciated that multiple campaigns of each of the types of incentives mentioned (e.g., Coupons, Gift Certificates, Points) may be designed and stored in the user table 92 for each user.

The gift certificate information 93, coupon information 95, and points information 97 describe incentives held by the user and may, in one example embodiment, the collectively regarded as an electronic wallet.

The gift certificate information 93 may include one or more gift certificates 99. The gift certificate 99 includes an incentive identification code 105, an originator 107, an account identifier 109, a currency 111, an action 113, an original amount 115, a current amount 117, and rules 119. The incentive identification code 105 identifies the incentive. The originator 107 identifies the issuer or originator of the incentive. For example, the issuer may be a user on the network-based marketplace 12 or the network-based marketplace 12. The account identifier 109 identifies an account on the payment processor server 41 that may be debited based on an authorization from the network-based marketplace 12. The currency 111 identifies the national currency of the incentive. The original amount 115 identifies the amount of the incentive at issuance. The current amount 117 identifies the value remaining. For example, the user may allocate portions of the original amount towards a transaction and the network-based marketplace 12 may update the current amount 117 accordingly. The rules 119 identify rules that the processing module 118 in the incentive engine 114 may use to validate the incentive. For example, the rule 119 may require the incentive to be applied to an item at checkout that is listed in a category that is identified by the rule. Another rule 119 may require an item at checkout to be transacted for an amount that is within a price range that is identified by the rule 119. Yet another rule 119 may require the incentive to be applied to an item identified at checkout that is listed by the seller that issued the incentive. Yet another rule 119 may require the incentive to be applied a particular type of charge at checkout (e.g., shipping charges).

The coupon information 95 may include one or more coupons 101. In addition to the previously described user incentive information the coupon 101 includes a description 123 and an expiration date 125. The description may be used to display a string that describes the coupon. The expiration date 125 indicates the date of expiration of the coupon.

The points information 97 may include one or points accounts 103. In addition to the previously described user incentive information the points account 103 may include points 127 and an exchange rate 129. The points 127 may be the current number total points stored in the account. The exchange rate may be used to compute a monetary amount. For example, an exchange rate may equate one point to 0.01 US Dollar (e.g., 1 cent).

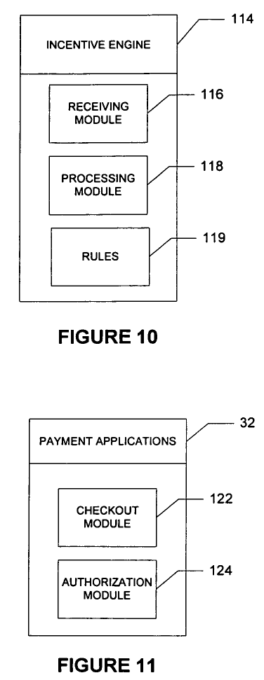

FIG. 10 is a block diagram illustrating an architecture of an incentive engine 114, according to one embodiment. The incentive engine 114 may execute on the network-based marketplace 12 (or any commerce server) and includes a receiving module 116, rules 119, and a processing module 118. The receiving module 116 may receive an incentive identification code from a user of the network-based marketplace 12. The incentive identification code may identify an incentive (e.g., coupon, gift certificate, points account, etc.) having an amount that may be used for partial payment for a transaction (e.g., item, shipping costs, etc). The receiving module 116 may further receive incentive identification codes that identify incentives for storage in an electronic wallet.

The processing module 118 determines whether an incentive is valid as proffered by the identified user and as proffered for the item(s) to be transacted by utilizing rules 119 that may be resident in the incentive engine 114 and identified by the respective incentives (e.g., coupons, gift certificates, points). Further, the processing module 118 may communicate incentive information to the payment processor server 41 that authorize the transfer of funds between accounts to facilitate the redemption of one or more incentives. The processing module 118 may further receive incentive generation information associated with a particular campaign or incentive program, generate one or more incentives based on the incentive generation information, and communicate the incentive to the buyer (e.g., via email, user interfaces, etc.).

FIG. 11 is a block diagram illustrating an architecture of payment applications 32, according to one embodiment. The payment applications 32 include a checkout module 122 and an authorization module 124. The checkout module 122 receives checkout information from the network-based marketplace 12, the checkout information including buyer identification, seller identification, item descriptions, item identifies, item amounts, seller identifier, buyer identifier, etc. The authorization module 124 requests and receives incentive information from the network-based marketplace 12 that authorizes the transfer of funds between accounts to facilitate the redemption of one or more incentives.

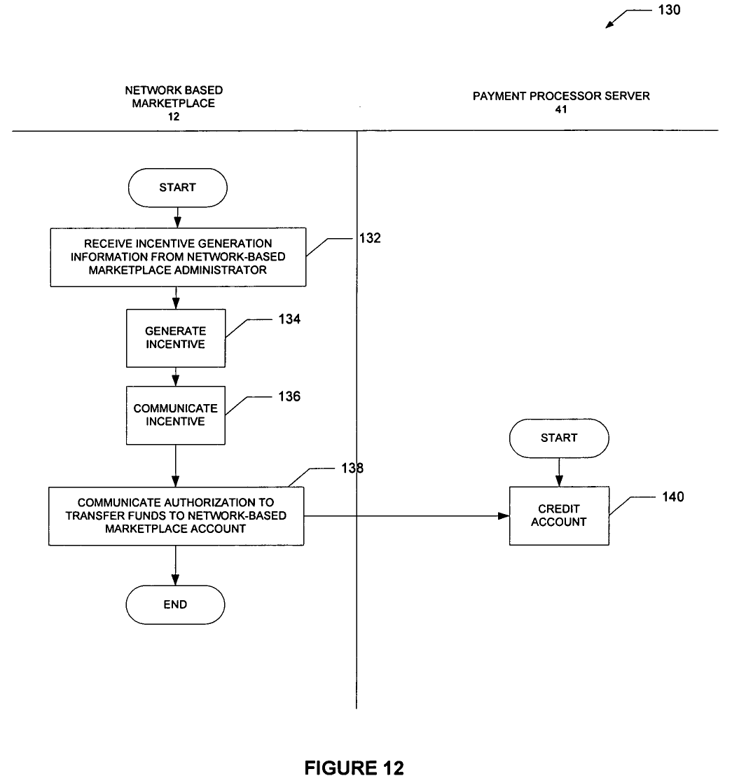

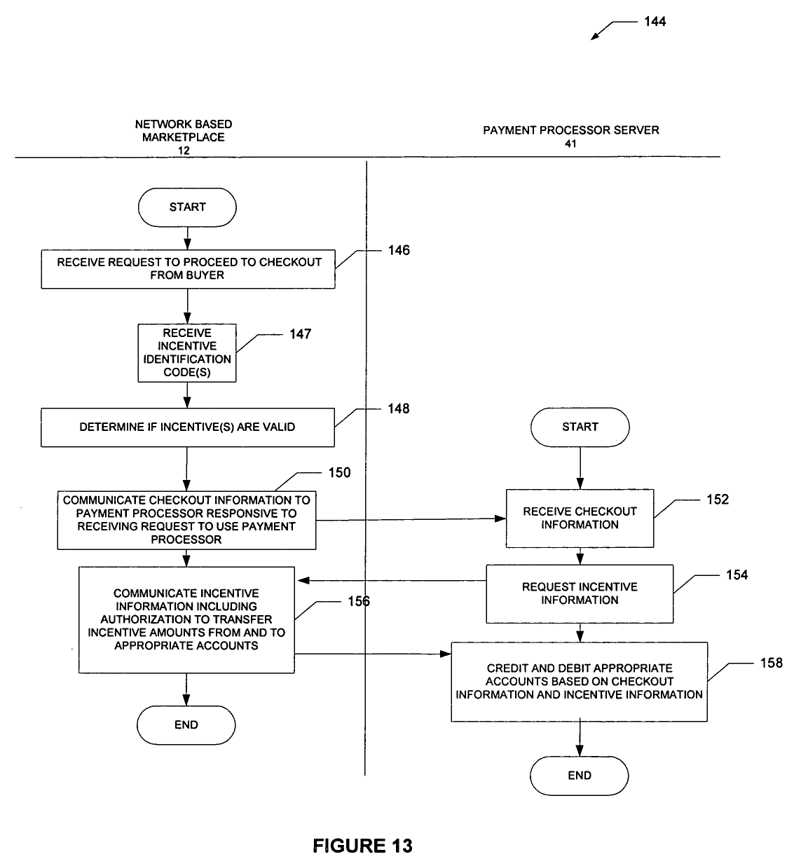

FIG. 12 is a flow chart illustrating a method 130 to issue an incentive, according to an embodiment. Illustrated on the left are operations performed by the network-based marketplace 12 and illustrated on the right are operations performed by the payment processor server 41. The method 130 commences at operation 132 with the receiving module 116 receiving incentive generation information from an administrator (or other authorized user) of the network-based marketplace 12. In one embodiment, the administrator may create an incentive campaign or program that issues coupons to first time buyers. For example, the administrator may enter a coupon description such as “Welcome,” an incentive identification code of ABC45678, a currency type of US Dollars, an amount of $9.00, an indication that the coupon may be selectable, campaign start and end dates, marking start and end dates, an indication to deliver to coupon via email, and an indication to utilize a rule that limits delivery of the email to first time users.

At operation 134, the network-based marketplace 12 utilizes the received incentive generation information to generate coupons for the coupon campaign.

At operation 136, the generated incentives, in the form of coupons, are communicated to the buyers or users on the network-based marketplace 12 by email, and other electronic medium (e.g., instant message etc). For example, the processing module 118 may send an email with a coupon to all users that registered on the network-based marketplace 12 (e.g., obtained a username and password) in the last six months. In another embodiment, the network-based marketplace 12 may communicate the incentive by posting the coupon on a number of web pages that may be viewed by users of the network-based marketplace 12. For example, coupons may be posted on checkout user interfaces (e.g., web pages), search result user interfaces, or other web pages that a user may navigate to perform various functions on the network-based marketplace 12. In one embodiment, a user that is viewing a “Welcome” coupon on a checkout webpage may store the coupon in an electronic wallet maintained by the network-based marketplace 12 by selecting a link. In another embodiment, the user may enter the incentive identification code, as it appears on the web page, via a user interface to store the coupon in the electronic wallet.

At operation 138, the processing module 118 communicates an authorization to transfer a monetary amount to an account identified with an account identifier 109 on the payment processor server 41. In one embodiment, the account 109 may belong to the network-based marketplace 12 and may be associated with the present campaign to generate “Welcome” coupons.

At operation 140, the payment processor server 41 receives the communication and credits the specified monetary amount to the account 109 of the network-based marketplace 12 on the payment processor server 41. In one embodiment, the payment processor server 41 may obtain the specified monetary amount from an account of network-based marketplace 12 that is maintained at a credit service (e.g., VISA, MasterCharge, Amex, etc.). In another embodiment, a transfer may be made from an account (e.g., checking, savings, etc.) of the network-based marketplace 12 that is maintained at a bank or some other financial institution.

The above example describes a coupon issued by the network-based marketplace 12. It will be appreciated that other embodiments of the method 130 may enable a user (e.g., a seller of the marketplace 12 or a retailer that operates the commerce platform) to issue an incentive.

FIG. 13 illustrates a method 144 to validate and process payment for an incentive. Illustrated on the left are operations performed on the network-based marketplace 12 and illustrated on the right are operations performed by the payment processor server 41. The method 144 commences at operation 146, at the network-based marketplace 12, with the receiving module 116 receiving a request to proceed to checkout from a buyer. For example, the buyer may have viewed listings on the network-based marketplace 12 and purchased items or won items in auctions and is now proceeding to pay for such items. Responsive to the request, the receiving module 116 displays a user interface that identifies incentives that are stored in an electronic wallet associated with the user. The user interface may be utilized by the user to identify incentives that the user may want to redeem or apply towards the purchase of items identified for checkout. In addition, the user interface may provide a box for the user to enter an incentive identification code that may identify an incentive to apply towards the items.

It will be appreciated that the user may redeem different types of incentives (e.g., gift certificates, coupons, points, etc.) in a single checkout. Further it will be appreciated that the user may redeem incentives that may have been issued from different sources in a single checkout. For example, incentives redeemed by the seller may have been issued by the network-based marketplace 12, a first seller on the network-based marketplace 12, a second seller on the network-based marketplace 12, etc. or any combination thereof.

At operation 147, the receiving module 116 receives incentive identification codes from the buyer. For example, the buyer may select an incentive from the user interface to retrieve incentive identification code from the electronic wallet, enter an incentive identification codes into a box provided on the user interface to identify an incentive identification code, or enter points into a box associated with a points account 103 to identify an incentive identification code.

At operation 148, the processing module 118 utilizes rules 119 identified by the incentives (e.g., gift certificate 99, coupon 101, points account 103) to validate each of the incentives. For example, a first coupon 101 may identify a rule 119 that requires an item in the checkout to be listed in a specific category. If the processing module 118 determines that none of the items identified for checkout were listed in a specific category then validation may fail for the first coupon 101. As another example, a second coupon 101 may identify a rule 119 that requires an item in the checkout to have a price within a price range. If the processing module 118 determines that none of the items identified for checkout were transacted for a price within the price range then validation may fail for the second coupon.

At operation 150, the processing module 118 communicates checkout information to the payment processor server 41 in response to the user selecting a payment processor server 41 for payment. The checkout information may include an account identifier that identifies the account of the buyer, an account identifier that identifies the account of seller, item identifiers that identify items that the buyer intends to transact with the seller, item information including text strings describing the respective items, item prices, etc., and shipping information including shipping costs.

At operation 152, the checkout module 122 on the payment processor server 41 receives the checkout information and, at operation 154, requests incentive information associated with the checkout (e.g., checkout information) from the network-based marketplace 12.

At operation 156, the processing module 118, at the network-based marketplace 12, communicates the incentive information to the payment processor server 41. For example, incentive information may include gift certificate information 93, coupon information 95 and points information 97, as previously described, including an authorization to transfer an amount from one or more accounts 109. In the present example, the incentive information includes an authorization to transfer an original amount 115 from an account 109 that belongs to the network-based marketplace 12 to an account of the buyer based on the value of a coupon that is being redeemed by the buyer.

At operation 158, the authorization module 124 utilizes the incentive information to transfer an amount corresponding to the various incentives from one or more accounts 109 to an account of the buyer. Further, the authorization module 124 utilizes the checkout information and the incentive information to make the necessary transfer of funds from the account of the buyer to the account of the seller to complete the transaction of the items.

The above example describes the redemption of a coupon issued by the network-based marketplace 12. It will be appreciated that another example may describe the redemption of a coupon that is issued by a user (e.g., seller) of the network-based marketplace 12 to other users (e.g., buyers) of the network-based marketplace 12. In such an example, the coupon may only be redeemed from the seller themselves (e.g., for items sold or auctioned by the seller). It will further be appreciated that other embodiments may include the redemption of multiple incentives issued by the network-based marketplace 12, multiple incentives issued by seller, or any combination thereof.

In another embodiment the incentive information may be communicated with the checkout information to the payment processor server 41. In this embodiment the payment processor server 41 may not be required to request incentive information; but rather, may receive the incentive information bundled together with the checkout information.

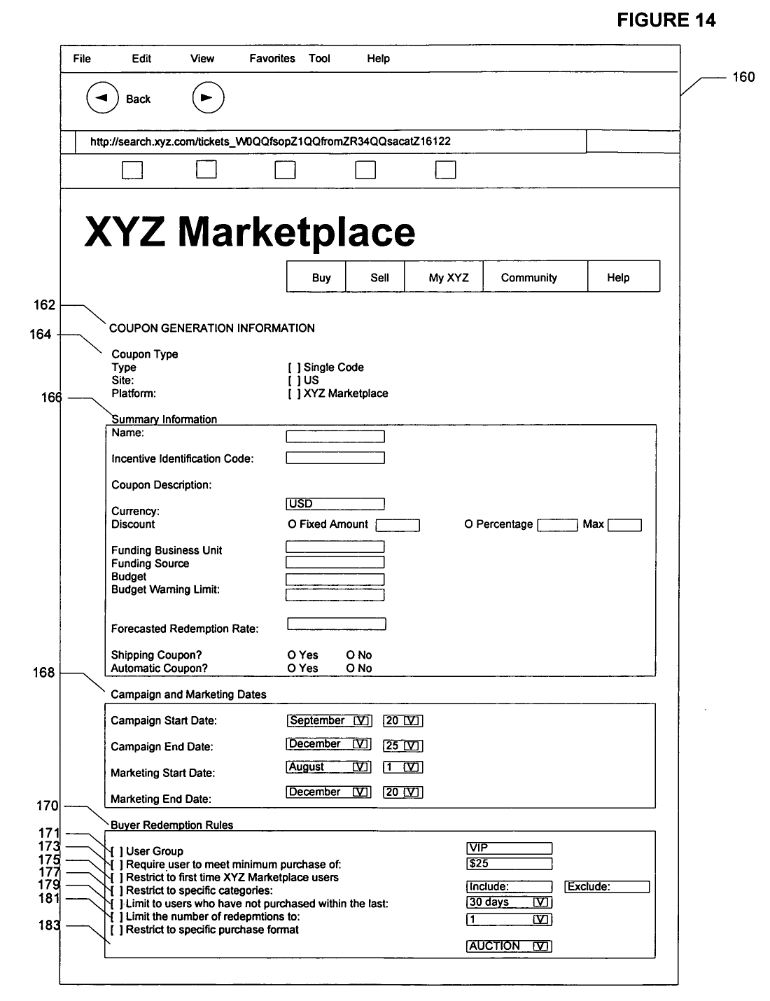

FIG. 14 is a representation of the user interface 160, according to one example embodiment, to generate a coupon campaign. The user interface 160 may be utilized to receive coupon generation information 162 from an administrator of the network-based marketplace 12 or a user of the network-based marketplace 12.

The coupon generation information 162 includes coupon type information 164, summary information 166, campaign and marketing dates 168, and rules 170. The coupon type 164 includes a type, a site and a platform. The type may be used by a network administrator to identify whether the coupon is single code or multi-code. The site field may be used to identify a particular site from which the coupon may be issued. The platform field identifies different electronic marketplaces within a site.

The summary information 166 is shown to include a box to enter a name to identify the coupon campaign. In one embodiment, the name may appear on user interfaces associated with the coupon, on email associated with the coupon or on the coupon itself. A box is also provided to enter the incentive identification code and a currency the type as previously described. Radio buttons are provided to indicate whether the coupon should be generated with a fixed amount or percentage. A box is provided to enter a fixed amount, and a box is provided to enter a percentage amount and a maximum amount that is not to be exceeded once the percentage amount is applied to the target amount (e.g., price of an item, shipping costs, etc.). Boxes are provided to enter a funding business unit (e.g., an accounting structure or process in the network-based marketplace 12 that is associated with the coupon campaign.) A box is provided to enter an account identifier 109 that identifies an account on the payment processor server 41. A box is provided to enter a budget that may be used to enter a monetary amount that may be transferred into an account identified by the account identifier 109. A box is provided to enter a budget warning limit. In one embodiment, the network-based marketplace 12 and the payment processor server 41 may use the warning limit to determine whether a warning should be communicated. For example, if the account 109 drops below the budget waning limit then a warning may be communicated. A box is provided to enter a forecasted redemption rate which in one embodiment may be used to calculate reports based on a coupon campaign. For example, a redemption rate of 10% forecasts out of 100 recipients of a coupon, 10 users redeems the coupon. Radio buttons are provided to identify a coupon as a shipping coupon that may be applied to shipping charges and an automatic coupon that may be applied automatically by the network-based marketplace 12 at checkout time without any action by the user.

The campaign and marketing dates 168 include boxes that may be used to enter campaign and marketing dates as previously described.

The rules 170 include rule 171, 173, 175, 177, 179, 181, 183 that are respectively associated with a checkbox that may be selected to trigger the processing module 118 to apply a corresponding rule 119 at validation time. It will be appreciated that the rules 119 are not limited by the rules 170; but rather, may be generated based on any coupon, gift certificate or points generation information.

The rule 171 is associated with a box to enter an indicator that identifies a group of users on the network-based marketplace 12 that may redeem the coupon. The rule 173 is associated with a box that may be used to enter a minimum amount of purchase at checkout before the coupon may be redeemed. The rule 175 may be used to restrict the coupon to recently registered users. The rule 177 may require that the coupon be redeemed only for items listed or not listed in the designated categories. For example the rule 177 is associated with boxes to enter an include list and exclude list. An item that appears in checkout that is listed in a category that is identified in the include list may pass validation. Further, an item that appears in checkout that is not listed in a category that is identified in the exclude list may pass validation. The rule 179 limits redemption to users who have not purchased within a period of time that may be entered in a corresponding box. The rule 181 may be utilized to limit the number of times a coupon may be used. For example, a coupon may be reused a number times entered in the box that corresponds to the rule 181. Finally, the rule 183 may be used to restrict redemption of the coupon towards items that have been transacted in a purchase format entered in a box that corresponds to the rule 183, as previously described.

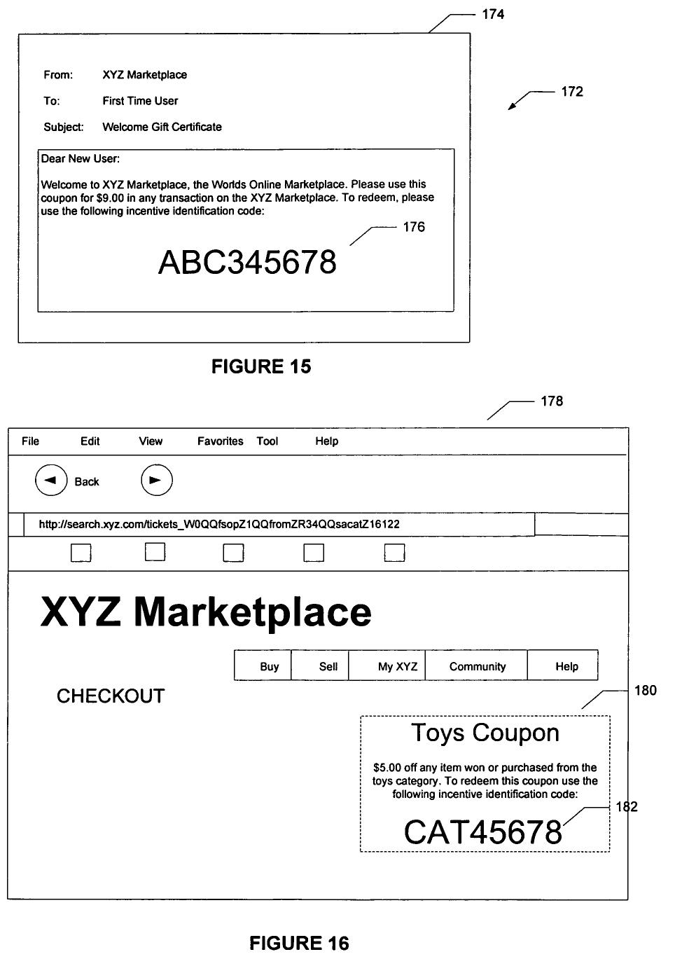

FIG. 15 is a representation of an e-mail user interface 172, according to one embodiment. The user interface 172 includes email text 174 to a first time user and is identified as a “Welcome Gift Certificate” in the subject part of the email text 174. The email text 174 includes an incentive identification code 176 that the recipient of the email may use to redeem the coupon. The face of the coupon indicates a $9 value and that the coupon may be used for any transaction on the XYZ marketplace.

FIG. 16 is a representation of a coupon presentation user interface 178, according to one embodiment. The user interface 178 includes a representation of a coupon 180. The coupon 180 may be redeemed for an item, in the example embodiment, that was listed in a “toys” category on the network-based marketplace 12. The coupon 180 further includes an incentive identification code 182 that may be entered by a user to store the coupon in an electronic wallet.

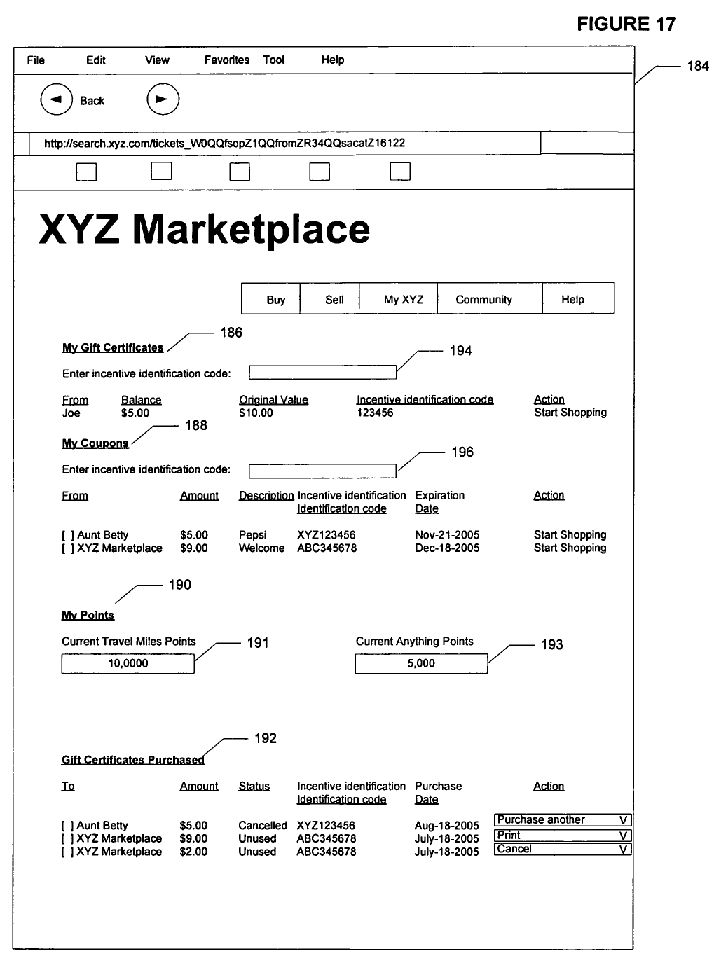

FIG. 17 is a representation of an incentive summary user interface 184, according to one embodiment that may be used by a user to view stored and accumulated incentives. The user interface 184 is shown to include areas 186, 188, 190, and 192. The area 186 includes gift certificates that may be presently held by the user. For example the area 186 includes a gift certificate from “Joe” that originally issued for $10.00 but has a present balance of $5.00. Thus, the gift certificate from “Joe” is partially redeemed. The area 186 further includes a box 194 that may be utilized by the user to enter incentive identification codes. Responsive to the user entering an incentive identification code for a gift certificate, the receiving module 116 may display the corresponding gift certificate in the area 186.

The area 188 includes coupons that may be presently held by the user. The area 188 further includes a box 196 that may be utilized by the user to enter incentive identification codes. Responsive to the user entering an incentive identification code for a coupon, the receiving module 116 may display the corresponding coupon in the area 188.

The area 190 displays points that may be currently held by the user. The area 190 displays two types of points held by the user, “Travel Miles Points” and “Anything Points.”

The area 192 includes gift certificates that have been purchased by the user. Each gift certificate is associated with an action field that may be utilized by the user to purchase a similar gift certificate, print the gift certificate, communicate the gift certificate, or cancel the gift certificate.

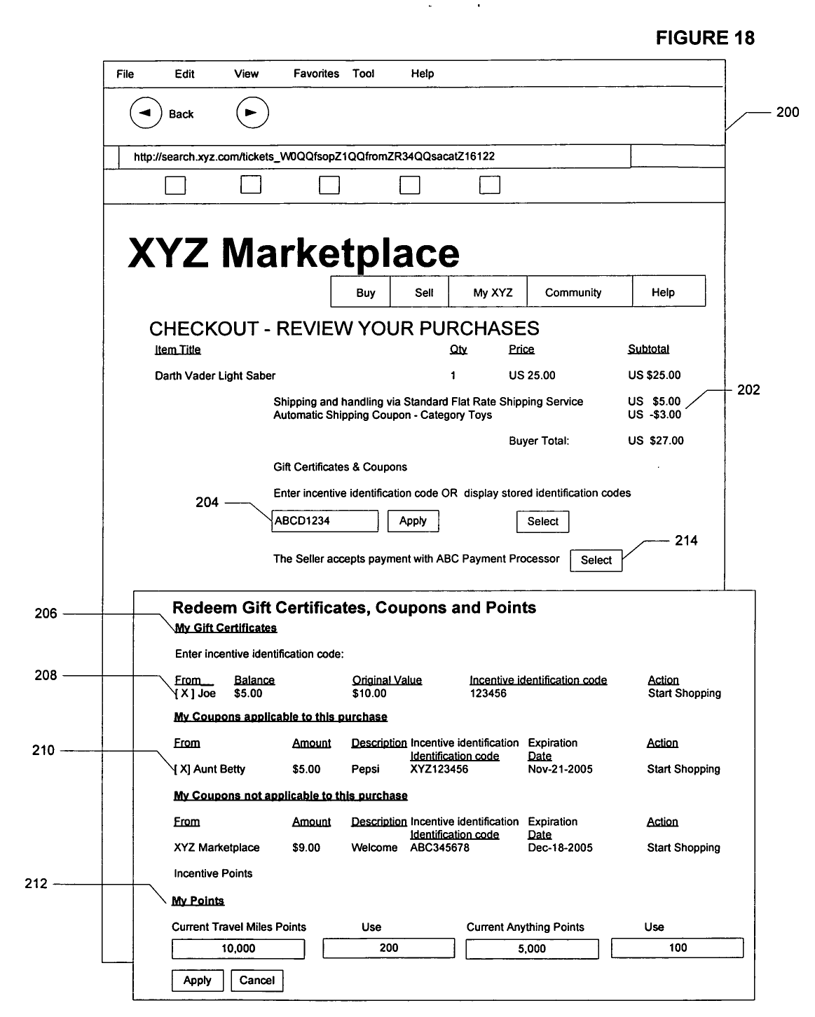

FIG. 18 is a representation of a checkout user interface 200 according to one embodiment, to review items at checkout. The user interface 200 is communicated to the user from the network-based marketplace 12 and includes coupons 202, 204, 208, 210 and points 212 that are indicated as applied towards the purchase of a Darth Vader light saber. The coupons include an automatic shipping coupon 202 that is automatically included on the user interface 200 by the network-based marketplace 12, a selectable coupon 204 that is identified by an incentive identification code entered by the user via the user interface 200, a gift certificate 208 from Joe that is selected on the user interface 200 by the user, and a gift certificate from Aunt Betty that is selected on the user interface 200 by the user. The user interface 200 further includes a button 214 that may be selected by the user to use the “ABC Payment Processor” server. Responsive to selection of the button 214 the processing module 118 on the network-based marketplace 12 communicates checkout information to the authorization module 124 on the payment processor server 41.

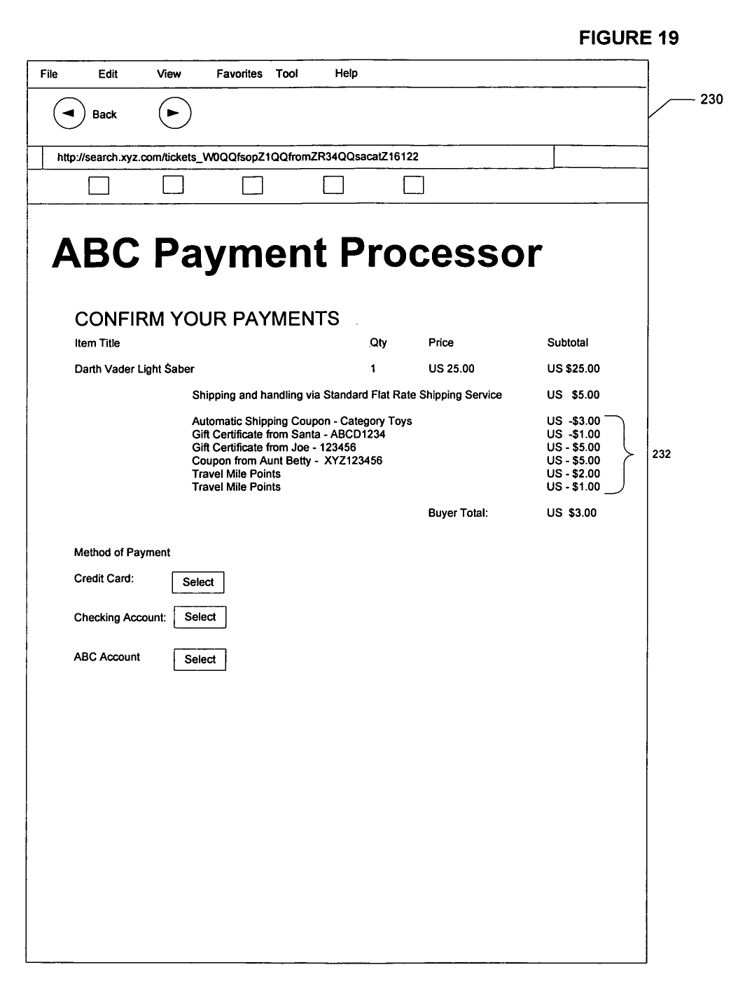

FIG. 19 is a representation of a payment confirmation user interface 230, according to one embodiment, to confirm payments. The user interface 230 is communicated to the user from the payment processor server 41 and includes incentives 232.

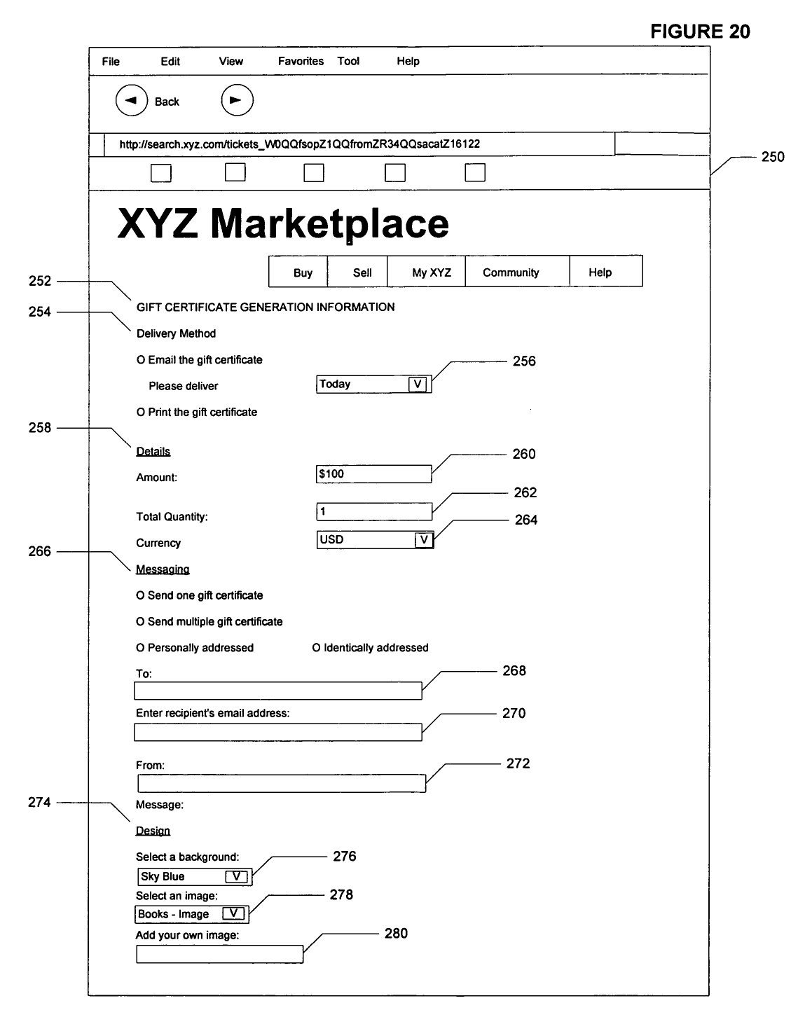

FIG. 20 is a representation of a configuration user interface 250, according to one embodiment, to configure one or more gift certificates. The user interface 250 is shown to include gift certificate generation information 252 that includes a delivery information 254, detail information 258, messaging information 266 and design information 278. The delivery information 254 includes radio buttons that may be selected by the user to email the gift certificate or to print the gift certificate. If the email radio button is selected, the user may further select a date from a pull down menu 256 to specify a date that the network-based marketplace 12 may communicate the email containing the gift certificate.

The details information 258 includes a box 260 where the user may enter a monetary amount, a box 262 where the user may enter a total quantity of gift certificates, and a box 264 where the user may enter a national currency.

The messaging information 266 includes radio buttons to send one or multiple gift certificates. If the multiple gift certificate radio button is selected the user must further select a radio button to personally address each gift certificate or a radio button to identically address the multiple gift certificates. The messaging information 266 further includes a box 268 to enter a name of the recipient, a box 270 to enter the email address of the recipient, and a box 272 to enter the name of the sender that may appear on the email and the gift certificate.

The design information 274 includes a pull down menu 276 to select the background design for the gift certificate, a pull down menu 278 to select an image provided by the network-based marketplace 12 that may appear on the gift certificate, and a box 280 enter to a network address (e.g., path, URL, etc) to identify a user image that may appear on the gift certificate.

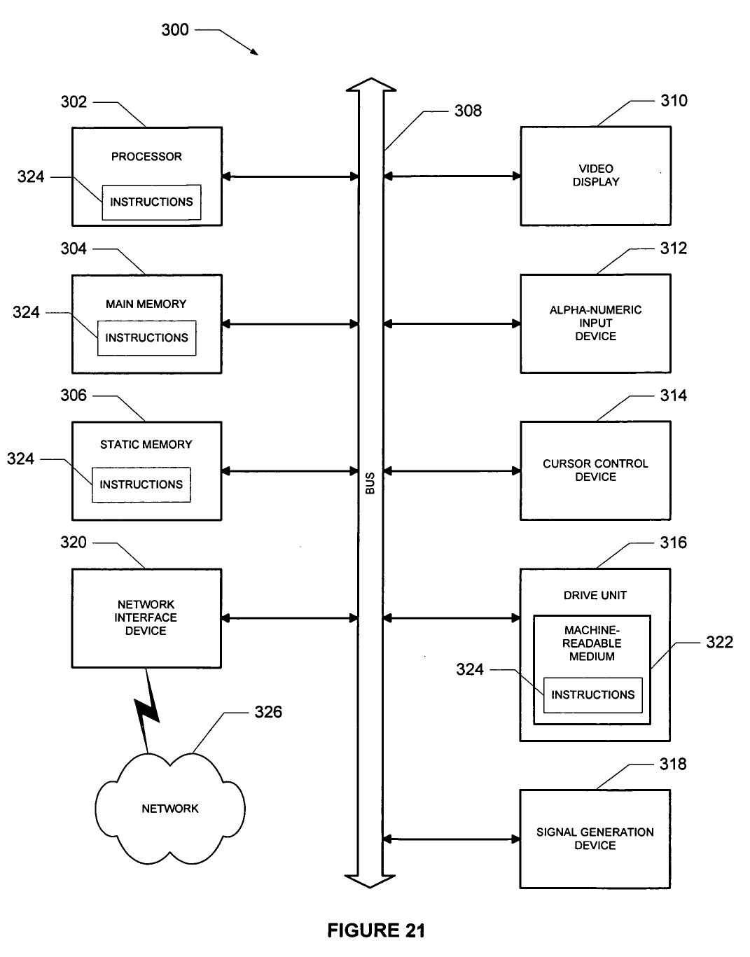

FIG. 21 shows a diagrammatic representation of machine in the example form of a computer system 300 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 300 includes a processor 302 (e.g., a central processing unit (CPU) a graphics processing unit (GPU) or both), a main memory 304 and a static memory 306, which communicate with each other via a bus 308. The computer system 300 may further include a video display unit 310 (e.g., a liquid crystal display (LCD) or a cathode ray tube (CRT)). The computer system 300 also includes an alphanumeric input device 312 (e.g., a keyboard), a cursor control device 314 (e.g., a mouse), a disk drive unit 316, a signal generation device 318 (e.g., a speaker) and a network interface device 320.

The disk drive unit 316 includes a machine-readable medium 322 on which is stored one or more sets of instructions (e.g., software 324) embodying any one or more of the methodologies or functions described herein. The software 324 may also reside, completely or at least partially, within the main memory 304 and/or within the processor 302 during execution thereof by the computer system 300, the main memory 304 and the processor 302 also constituting machine-readable media.

The software 324 may further be transmitted or received over a network 326 via the network interface device 320.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. The term “machine-readable medium” shall accordingly be taken to include, but not be limited to, solid-state memories, optical and magnetic media, and carrier wave signals.

Thus, a method and system to process an incentive have been described. Although the present disclosure has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense.

What is claimed is:

1. A system comprising:
a receiving module to receive an incentive identification code that identifies an incentive amount to be used for at least a partial payment for a transaction; and
a processing module to:
determine whether the incentive is valid; and
if the incentive is valid, to communicate incentive information to a payment processor server,
the incentive information including an authorization that authorizes the payment processor server to transfer the incentive amount as the at least partial payment for the transaction.

2. The system of claim 1, wherein the transaction includes an auction-based sale of at least one item from a seller to a buyer and shipping of the least one item.

3. The system of claim 1, wherein the transaction includes a fixed price-based sale of at least one item from a seller to a buyer and shipping of the least one item.

4. The system of claim 3, wherein the processing module is to determine whether a feedback score of the buyer exceeds a threshold feedback score.

5. The system of claim 3, wherein the authorization authorizes the payment processor server to transfer the incentive amount from an account of a seller to an account of a buyer.

6. The system of claim 1, wherein the authorization authorizes the payment processor server to transfer the incentive amount from an account of a commerce server to an account of a buyer.

7. The system of claim 1, wherein the processing module is to receive incentive generation information associated with an incentive program, to generate the incentive based on the incentive generation information, and to communicate the incentive to the buyer.

8. The system of claim 7, wherein the incentive generation information includes any one from a group including an amount, an image that is displayed with the incentive, an image that is uploaded with the incentive, a background that is displayed with the incentive, and a message this is communicated with the incentive.

9. The system of claim 1, wherein the incentive includes any one from a group including a gift certificate, points, and a coupon.

10. The system of claim 1, wherein processing module is to determine whether an item transacted in terms of the transaction is classified in a category that is identified by the incentive.

11. The system of claim 1, wherein the processing module is to determine whether a transaction amount for the transaction that is within a price range that is identified by the incentive.

12. The system of claim 1, wherein the processing module is to determine whether the transaction involves a seller that is identified by the incentive.

13. A method comprising:
receiving an incentive identification code that identifies an incentive amount to be used for at least a partial payment for a transaction;
determining whether the incentive is valid; and
if the incentive is valid, communicating incentive information to a payment processor server, the incentive information including an authorization that authorizes the payment processor server to transfer the incentive amount as the at least partial payment for the transaction.

14. The method of claim 13, wherein the transaction includes an auction-based sale of at least one item from a seller to a buyer and shipping of the at least one item.

15. The method of claim 13, wherein the transaction includes a fixed price-based sale of at least one item from a seller to a buyer and shipping of the least one item.

16. The method of claim 15, wherein the determining whether the incentive is valid includes determining whether a feedback score of the buyer exceeds a threshold feedback score.

17. The method of claim 15, wherein the authorization authorizes the payment processor server to transfer the incentive amount from an account of a seller to an account of a buyer.

18. The method of claim 13, wherein the authorization authorizes the payment processor server to transfer the incentive amount from an account of a commerce server to an account of a buyer.

19. The method of claim 13, further including, issuing the incentive, wherein the issuing of the incentive includes receiving incentive generation information associated with an incentive program, generating the incentive based on the incentive generation information, and communicating the incentive to the buyer.

20. The method of claim 19, wherein the incentive generation information includes any one from a group including an amount, an image that is displayed with the incentive, an image that is uploaded with the incentive, a background that is displayed with the incentive, and a message this is communicated with the incentive.

21. The method of claim 13, wherein the incentive includes any one from a group including a gift certificate, points, and a coupon.

22. The method of claim 13, wherein the determining whether the incentive is valid includes determining whether an item transacted in terms of the transaction is classified in a category that is identified by the coupon.

23. The method of claim 13, wherein the determining whether the incentive is valid includes determining whether a transaction amount for the transaction is within a price range that is identified by the incentive.

24. The method of claim 13, wherein the determining whether the incentive is valid includes determining whether the transaction involves a seller that is identified by the incentive.

25. A tangible machine readable medium storing a set of instructions that, when executed by a machine, cause the machine to:
receive an incentive identification code that identifies an incentive that identifies an incentive amount to be used for at least a partial payment for a transaction;
determine whether the incentive is valid; and
if the incentive is valid, communicate incentive information to a payment processor server, the incentive information including an authorization that authorizes the payment processor server to transfer the amount as at least partial payment for the transaction.

26. A system comprising:
a first means for receiving an incentive identification code that identifies an incentive amount to be used for at least a partial payment for a transaction; and
a second means for:
determining whether the incentive is valid; and
if the incentive is valid, for communicating incentive information to a payment processor server,
the incentive information including an authorization that authorizes the payment processor server to transfer the incentive amount as at least partial payment for the transaction.
